(19) United States
(12) Patent Application Publication
(10) Pub. No.: US 2026/0188678 A1
(43) Pub. Date: Jul. 2, 2026

(54) ALL-SOLID-STATE BATTERY

(71) Applicant: LG ELECTRONICS INC., Seoul (KR)

(72) Inventors: Byungjoon RHEE, Seoul (KR); Hwanjoon CHOI, Seoul (KR); Kyoungtae WI, Seoul (KR)

(73) Assignee: LG ELECTRONICS INC., Seoul (KR)

(21) Appl. No.: 19/131,158

(22) PCT Filed: Nov. 17, 2022
(86) PCT No.: PCT/KR2022/018211

§ 371 Date: May 19, 2025

(51) Int. Cl. H01M 4/62; H01M 4/04; H01M 4/36; H01M 10/0585; H01M 10/42

(52) U.S. Cl. CPC H01M 4/62; H01M 4/043; H01M 4/366; H01M 10/0585; H01M 10/4235

(57) ABSTRACT

The present disclosure relates to an all-solid-state battery that may be applied to a secondary battery and that uses a solid electrolyte, for example, as a secondary battery. In the present disclosure, the all-solid-state battery that uses a solid electrolyte comprises a cathode layer comprising: cathode active material particles; and electrolyte particles distributed in contact with the cathode active material particles, wherein the electrolyte particles may comprise an electrolyte layer coated on an elastic core.

### TECHNICAL FIELD

Embodiments relate to an all-solid-state battery applicable to secondary batteries, for example, an all-solid-state battery using solid electrolytes as a secondary battery.

### BACKGROUND ART

Secondary batteries that may be charged and discharged are widely used as large-capacity power storage batteries for electric vehicles and power storage systems, and as small, high-performance energy sources for portable electronic devices such as mobile phones, camcorders, and laptops.

As a secondary battery, a lithium-ion battery has an advantage of convenience of use, such as larger capacity per unit area, lower self-discharge rate and no memory effect compared to nickel-manganese batteries or nickel-cadmium batteries.

Lithium-ion batteries include a carbon-based anode, an electrolyte containing an organic solvent, and a lithium oxide cathode, and are characterized in that lithium ions are released from the cathode and moved to the carbon-based anode through the electrolyte during charging, and a reverse process to the charging occurs during discharging based on chemical reactions occurring at the cathode and anode.

However, lithium-ion batteries use a liquid electrolyte containing an organic solvent and thus have problems associated with battery stability due to leakage and shock caused by the use of highly volatile organic solvents.

Therefore, in order to secure the safety of lithium-ion batteries, research on all-solid-state batteries using solid electrolytes instead of liquid electrolytes is actively being conducted.

The all-solid-state batteries do not contain flammable organic solvents and thus may simplify safety devices and exhibit excellent manufacturing costs and productivity. In addition, all-solid-state batteries using sulfide solid electrolytes have the advantage of excellent lithium-ion conductivity.

However, all-solid-state batteries have limitations of low energy density and output performance compared to lithium-ion batteries using conventional liquid electrolytes. Therefore, improvements are needed in various aspects such as materials and structural design to solve these problems.

FIG. 1 is a schematic diagram illustrating a configuration of a typical all-solid-state battery. The typical all-solid-state battery broadly includes a cathode layer 10, a solid electrolyte layer 20, and an anode 30. The cathode layer 10, the solid electrolyte layer 20, and the anode 30 may be disposed between a cathode 40 and an anode 50.

The cathode layer 10 includes a cathode active material (cathode material; 11) and a solid electrolyte 12, and may further include a conductive material (not shown) and a binder 13.

The solid electrolyte layer 20 may include a solid electrolyte 21.

The anode layer 30 may include an anode active material 31 similar to the cathode layer 10. In addition, the anode layer 30 may further include a conductive material and a binder.

The all-solid-state batteries are battery systems that use a solid electrolyte instead of an organic electrolyte of commercial lithium secondary batteries and exhibit high safety as well as high energy and high output density using highly conductive and flame-retardant materials.

Unlike liquid-based batteries, all-solid-state batteries use solid electrolytes which also serve as separators. In addition, the all-solid-state batteries have advantages of forming a simpler battery system than current lithium-ion batteries, such as simplifying the package by manufacturing high-voltage single cells using bipolar stacking.

However, there are problems in which mobile lithium participating in the reversible reaction is consumed due to electrochemical side reactions during initial charging and discharging, and the number of effective lithium ions decreases rapidly from the first discharge, which reduces the energy of the electrode.

Accordingly, voids are readily formed between active material particles and electrolytes. As a result, the interfacial resistance between the active material particles and the electrolyte may increase.

Therefore, a solution to solve this problem is required.

### Disclosure

### Technical Task

One technical task of the present disclosure is to provide an all-solid-state battery that is capable of suppressing a phenomenon in which various interfacial issues occur.

For example, the present disclosure provides an all-solid-state battery that is capable of suppressing a phenomenon in which voids are formed between a cathode active material and an electrolyte.

Another technical task of the present disclosure is to provide an all-solid-state battery that is capable of suppressing a phenomenon in which an interface is formed between a cathode active material and a cathode.

Another technical task of the present disclosure is to provide an all-solid-state battery that is capable of suppressing a phenomenon in which voids are formed between an anode active material and an electrolyte.

Another technical task of the present disclosure is to provide an all-solid-state battery that is capable of suppressing a phenomenon in which an interface is formed between an anode active material and an anode.

### Technical Solutions

In one technical aspect of the present disclosure, provided is an all-solid-state battery using a solid electrolyte, the all-solid-state battery including a cathode layer including cathode active material particles and electrolyte particles distributed in contact with the cathode active material particles, wherein the electrolyte particles include an electrolyte layer coated on an elastic core.

In an embodiment, the elastic core may include polymer particles.

In an embodiment, the cathode layer may be provided by mechanical compression.

In an embodiment, elasticity of the elastic core may correspond to a restoring force against deformation of the cathode layer due to mechanical compression.

In an embodiment, the restoring force may be formed when a size of the cathode active material particles is reduced.

In an embodiment, the restoring force may be formed when ions escape from the cathode active material particles.

In an embodiment, the all-solid-state battery may further include a package structure configured to package the electrolyte particles in a compressed state.

The cathode active material particles may be coated with an electrolyte.

A size of the electrolyte particles may be larger than a size of the cathode active material particles.

In one technical aspect of the present disclosure, provided is an all-solid-state battery including a cathode layer, an anode layer, and a solid electrolyte layer disposed between the cathode layer and the anode layer, wherein the cathode layer includes electrolyte particles including an electrolyte layer coated on an elastic core.

The cathode layer may further include cathode active material particles contacting the electrolyte particles.

The electrolyte particles may be provided by mechanical compression between the cathode layer and the anode layer.

### Advantageous Effects

One embodiment of the present disclosure has the following effects.

First, according to the embodiment of the present disclosure, the phenomenon in which voids are formed between the cathode active material and the electrolyte may be suppressed and thus the phenomenon of increased interfacial resistance of the cathode active material may be suppressed.

In addition, the phenomenon of increased interfacial resistance between the cathode active material and the cathode may be suppressed.

In addition, the phenomenon of increased interfacial resistance between the anode active material and the electrolyte may be suppressed.

In addition, the phenomenon of increased interfacial resistance between the anode active material and the anode may be suppressed.

The effects that may be obtained from embodiments are not limited to the effects mentioned above and other effects that are not mentioned may be clearly derived and understood by those skilled in the art based on the detailed description below.

### DESCRIPTION OF DRAWINGS

FIG. 1 is a schematic diagram illustrating a configuration of a typical all-solid-state battery.

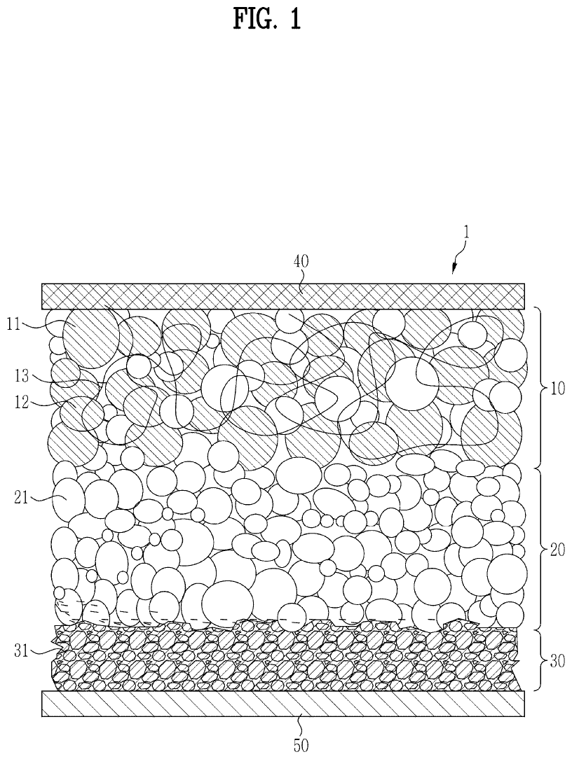

FIG. 2 is a conceptual diagram illustrating an all-solid-state battery according to a first embodiment of the present disclosure.

FIG. 3 is a conceptual diagram illustrating electrolyte particles of an all-solid-state battery according to one embodiment of the present disclosure.

FIG. 4 is a conceptual diagram illustrating cathode active material particles of an all-solid-state battery according to one embodiment of the present disclosure.

FIG. 5 is a conceptual diagram illustrating a state in which pressure is applied to an all-solid-state battery according to the first embodiment of the present disclosure.

FIG. 6 is a conceptual diagram illustrating a state in which pressure is applied to an all-solid-state battery according to the first embodiment of the present disclosure.

FIG. 7 is a conceptual diagram illustrating an example of an effect of an all-solid-state battery to which pressure is applied according to the first embodiment of the present disclosure.

FIG. 8 is a conceptual diagram illustrating an overall structure of the all-solid-state battery according to the first embodiment of the present disclosure.

FIG. 9 is a conceptual diagram illustrating movement of lithium ions in a typical all-solid-state battery.

FIG. 10 is a conceptual diagram illustrating a state in which voids are formed as part of FIG. 9.

FIG. 11 is a conceptual diagram illustrating an all-solid-state battery according to a second embodiment of the present disclosure.

FIG. 12 is a conceptual diagram illustrating an overall structure of the all-solid-state battery according to the second embodiment of the present disclosure.

FIG. 13 is a conceptual diagram illustrating an all-solid-state battery according to a third embodiment of the present disclosure.

FIG. 14 is a conceptual diagram illustrating an overall structure of the all-solid-state battery according to the third embodiment of the present disclosure.

FIG. 15 is a conceptual diagram illustrating an all-solid-state battery according to a fourth embodiment of the present disclosure.

FIG. 16 is a conceptual diagram illustrating an overall structure of the all-solid-state battery according to the fourth embodiment of the present disclosure.

### BEST MODE FOR DISCLOSURE

Reference will now be made in detail to embodiments of the present disclosure, examples of which are illustrated in the accompanying drawings. Wherever possible, the same reference numbers will be used throughout the drawings to refer to the same or like parts, and redundant description thereof will be omitted. As used herein, the suffixes “module” and “unit” are added or used interchangeably to facilitate preparation of this specification and are not intended to suggest distinct meanings or functions.

In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification.

Furthermore, although the drawings are separately described for simplicity, embodiments implemented by combining at least two or more drawings are also within the scope of the present disclosure.

In addition, when an element such as a layer, region or module is described as being “on” another element, it is to be understood that the element may be directly on the other element or there may be an intermediate element between them.

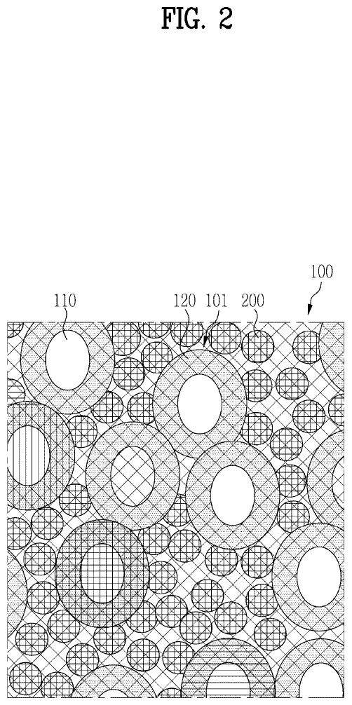

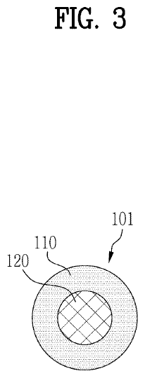

FIG. 2 is a conceptual diagram illustrating an all-solid-state battery according to a first embodiment of the present disclosure. FIG. 3 is a conceptual diagram illustrating electrolyte particles of an all-solid-state battery according to one embodiment of the present disclosure.

Referring to FIG. 2, a main configuration of the cathode layer 100 of the all-solid-state battery is provided. The all-solid-state battery may include a cathode layer 100 including cathode active material particles 200 and electrolyte particles 101 distributed in contact with the cathode active material particles 200.

Here, the electrolyte particles 101 may include an electrolyte layer 110 coated on an elastic core 120. As an exemplary embodiment, the elastic core 120 may include polymer particles. In addition, the electrolyte layer 110 may be coated on the outer surface of the elastic core 120 having a particle shape.

Referring to FIG. 3, the particle size of the elastic core 120 may be about 0.1 μm or less. In addition, the thickness of the electrolyte layer 110 may be sufficient to cover the outer surface of the elastic core 120. That is, the thickness of the electrolyte layer 110 may not be significantly limited as long as the electrolyte layer 110 may continuously cover the outer surface of the elastic core 120.

The cathode active material particles 200 may also be referred to as “cathode material” or “cathode activating material particles”. According to the present embodiment, the size of the cathode active material particles 200 may be smaller than the size of the electrolyte particles 101.

These cathode active material particles 200 are surrounded by the electrolyte particles 101, so that lithium ions (Li⁺) discharged from the cathode active material particles 200 move through the electrolyte particles 101. In this case, the electrolyte particles 101 include the electrolyte layer 110 coated on the elastic core 120 and lithium ions (Li⁺) may move through the electrolyte layer 120.

In this case, since the electrolyte particle 101 includes an electrolyte layer 110 coated on an elastic core 120 having elasticity, the possibility of a void being formed between the cathode active material particle 200 and the electrolyte particle 101 is significantly reduced, so that an interfacial issue that commonly occurs in an all-solid-state battery may be suppressed.

In other words, in a typical all-solid-state battery, a void is readily formed between the cathode active material particle 200 and the electrolyte particle 101 during charging and discharging, thus leading to an increase in interface resistance. However, interfacial issue may be significantly suppressed because contact is secured and maintained between the cathode active material particle 200 and the electrolyte particle 101 by the elastic force of the elastic core 120.

According to the elasticity of the elastic core 120, when external force is applied or deformation is applied, the elastic core 120 may be compressed and reduced in size, so that the size of the electrolyte particle 101 may be reduced or the shape thereof may be deformed. In this process, contact may be maintained between the cathode active material particle 200 and the electrolyte particle 101.

In addition, when the external force is removed or reduced, the size of the elastic core 120 may be restored again, so that contact may be maintained between the cathode active material particle 200 and the electrolyte particle 101.

The external force may be removed or reduced when the size of the cathode active material particle 200 is reduced due to the generation of lithium ions. In addition, this case may occur when ions including lithium ions escape from the cathode active material particle 200. This will be described in detail later.

According to the present embodiment, the size of the electrolyte particles 101 may be larger than that of the cathode active material particles 200. As can be seen from FIG. 2, the cathode active material particles 200 are distributed between relatively large-sized electrolyte particles 101.

The cathode active material particles 200 may be solid and may be lithium, nickel, manganese, cobalt, or the like. However, the embodiment of the present disclosure is not limited thereto.

Meanwhile, the electrolyte layer 110 may be a sulfide-based, oxide-based, polymer-based, or composite-based (hybrid) material containing lithium. However, the embodiment of the present disclosure is not limited thereto.

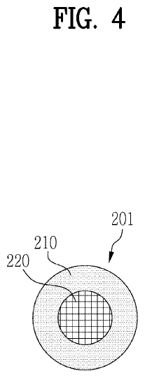

FIG. 4 is a conceptual diagram illustrating a cathode active material particle of an all-solid-state battery according to one embodiment of the present disclosure.

According to an embodiment, the cathode active material particle 201 may be formed by coating cathode active material core 220 with an electrolyte layer 210.

The electrolyte layer 210 may have a thickness sufficient to cover the outer surface of the cathode active material core 220. That is, the thickness of the electrolyte layer 210 may not be significantly limited as long as it may continuously cover the outer surface of the cathode active material core 220.

As such, the surface resistance applied to lithium ions may be further reduced by the cathode active material particle 201 formed by coating the cathode active material core 220 with the electrolyte layer 210.

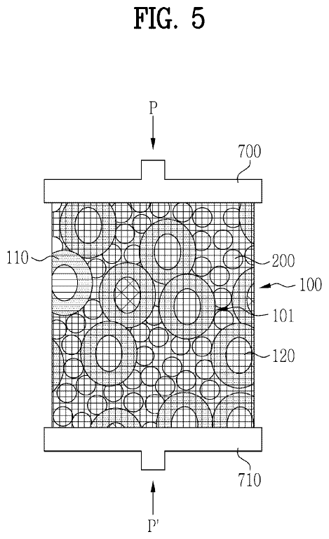

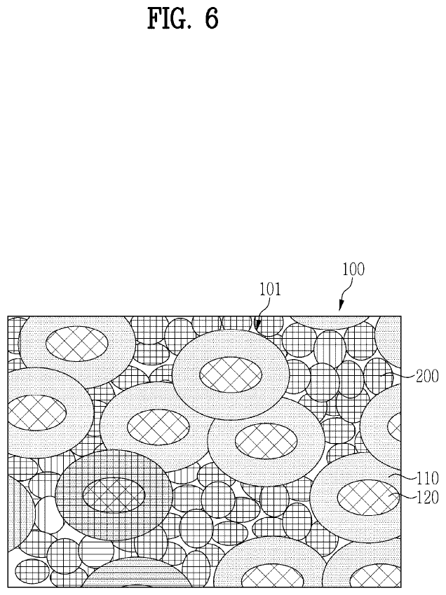

FIG. 5 is a conceptual diagram illustrating a state in which pressure is applied to an all-solid-state battery according to a first embodiment of the present disclosure. FIG. 6 is a conceptual diagram illustrating a state in which pressure is applied to the all-solid-state battery according to the first embodiment of the present disclosure.

As described above, the all-solid-state battery has problems in which mobile lithium participating in the reversible reaction is consumed due to electrochemical side reactions during initial charging and discharging, and the number of effective lithium ions decreases rapidly from the first discharge, which reduces the energy of the electrode. This phenomenon may become more severe as the discharge continues. Accordingly, a void is readily formed between the cathode active material particles 200 and the electrolyte particles 101.

In this case, since the electrolyte particle 101 includes an electrolyte layer 110 coated on an elastic core 120 having elasticity, the possibility of a void being formed between the cathode active material particle 200 and the electrolyte particle 101 is significantly reduced, so that an interfacial issue that commonly occurs in an all-solid-state battery may be suppressed.

However, the occurrence of the void may be minimized by applying pressure to the cathode layer 100 including the cathode active material particle 200 and the electrolyte particle 101 to compress the cathode layer 100.

As a specific example, the cathode layer 100 may be compressed using an actuator (not shown) for applying pressure to one or both sides of the cathode layer 100. For example, as shown in FIG. 5, plates 700 and 710 capable of applying pressure to both sides of the cathode layer 100 may be disposed and pressure P and P′ may be applied to the cathode layer 100 in opposite directions facing each other.

FIG. 6 shows a state in which pressure is applied to the cathode layer 100. Referring to FIG. 6, the shape of the electrolyte particle 101 including the elastic core 120 is mainly deformed by the pressures P and P′. At this time, the cathode active material particle 200 may also be deformed by the pressures P and P′. However, since the electrolyte particle 101 includes the elastic core 120, it may be deformed more than the cathode active material particle 200.

This compression causes the cathode active material particle 200 and the electrolyte particle 101 to closely contact each other.

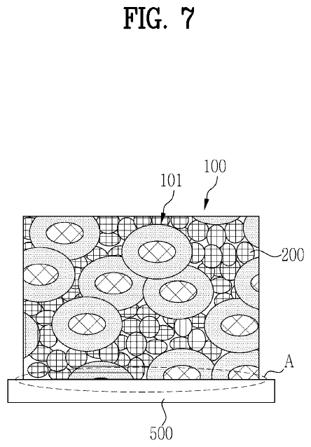

FIG. 7 is a conceptual diagram illustrating an example of the effect of the all-solid-state battery to which pressure is applied according to the first embodiment of the present disclosure.

Referring to FIG. 7, as described above, the interface A between the anode collector electrode 500 and the cathode layer 100 is shown when the all-solid-state battery including the cathode layer 100 is compressed.

When the all-solid-state battery including the cathode layer 100 is compressed, the void does not exist at the interface A between the cathode layer 100 and the collector electrode 500, and the cathode layer 100 may be in closer contact with the collector electrode 500.

That is, by compressing the all-solid-state battery including the cathode layer 100, the cathode active material particles 200 and the electrolyte particles 101 may be kept in close contact, and the cathode layer 100 including the cathode active material particles 200 and the electrolyte particles 101, and the anode collector electrode 500 may be kept in close contact.

As a result, the problem caused by the interface where the resistance between the interfaces increases may be solved.

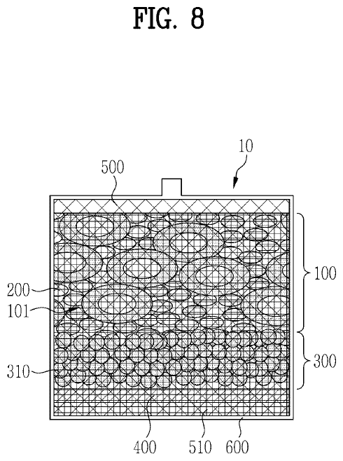

FIG. 8 is a conceptual diagram illustrating the overall structure of the all-solid-state battery according to the first embodiment of the present disclosure.

Referring to FIG. 8, the all-solid-state battery 10 according to the first embodiment of the present disclosure may include a cathode layer 100 described above and an anode collector electrode 500 disposed on one side of the cathode layer 100, and an anode layer 400 may be disposed on the other side of the cathode layer 100. In addition, a solid electrolyte layer 300 may be disposed between the cathode layer 100 and the anode layer 400.

A plurality of solid electrolyte particles 310 may be disposed in the form of layers in the solid electrolyte layer 300 between the cathode layer 100 and the anode layer 400.

As described above, the cathode layer 100 may include cathode active material particles 200 and electrolyte particles 101. Hereinafter, redundant descriptions of the cathode layer 100 will be omitted.

The solid electrolyte layer 300 may be disposed on one side of the anode layer 400 and a cathode collector 510 may be disposed on the other side of the anode layer 400.

Here, the anode layer 400 may be formed as a metal layer containing lithium. In this case, the anode layer 400 may form a very thin layer.

Meanwhile, such an all-solid-state battery 10 may further include a package structure 600 configured to package the compressed electrolyte particles 101. That is, the compressed state of the all-solid-state battery 10 including the electrolyte particles 101 may be maintained by the package structure 600. Here, the package structure 600 is briefly shown. This package structure 600 may include a mechanical structure (for example, a bolt penetrating the all-solid-state battery 10 and a nut connected to the bolt) that may maintain the compressed state.

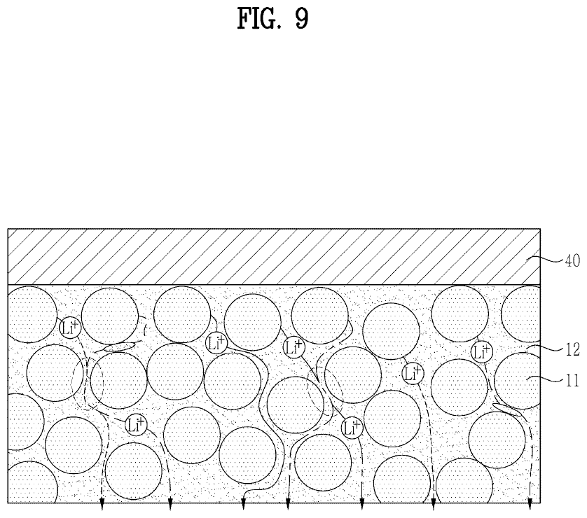

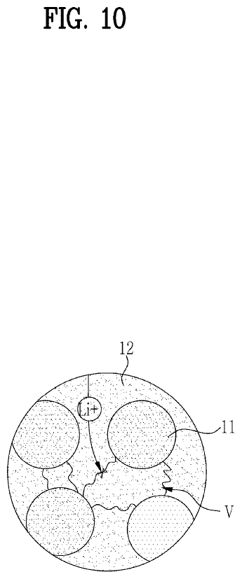

FIG. 9 is a conceptual diagram illustrating the movement of lithium ions in a typical all-solid-state battery. In addition, FIG. 10 is a conceptual diagram illustrating a state in which a void is formed as part of FIG. 9.

As described above, unlike a liquid battery, in an all-solid-state battery, the mobile lithium participating in the reversible reaction is consumed due to the electrochemical side reaction during the initial charging and discharging process, and as charging and discharging are repeated, the number of effective lithium ions rapidly decreases, resulting in a problem in which the energy of the electrode decreases.

Accordingly, as the size of the cathode active material particles 200 decreases, a void is readily formed between the cathode active material particles 200 and the electrolyte particles 101. This problem may be referred to an “interfacial issue”.

Referring to FIG. 9, lithium ions (Li⁺) are produced from the cathode active material (cathode material; 11) and move through the solid electrolyte 12.

A void V is present between the solid electrolytes 12 and thus may become larger as charging and discharging are repeated.

FIG. 10 schematically shows a state in which the movement of lithium ions (Li⁺) is stopped by the void V. In the liquid battery, the void V may be easily filled, but in the all-solid-state battery, filling the void V may be difficult because the all-solid-state battery includes a solid electrolyte. Accordingly, the movement of lithium ions may be stopped, which may lead to an increase in resistance.

However, according to the embodiment of the present disclosure described above, since the electrolyte particle 101 includes an electrolyte layer 110 coated on an elastic core 120 having elasticity, the possibility of a void being formed between the cathode active material particle 200 and the electrolyte particle 101 is significantly reduced, so that an interfacial issue that commonly occurs in an all-solid-state battery may be suppressed.

In addition, the occurrence of voids may be minimized by applying pressure to the cathode layer 100 including the cathode active material particles 200 and the electrolyte particles 101 to compress the cathode layer 100.

As described above, the elastic core 120 of the electrolyte particles 101 may include polymer particles. In addition, the electrolyte layer 110 may be coated on the outer surface of the elastic core 120 having a particle shape.

The polymer may be typically one of styrene, acryl, and a mixture thereof. Most of polymers such as PC, PET, PMMA, PVC, PS, PP, HDPE, PTFE, and LDPE in addition to this polymer may have an elastic modulus (Young's modulus) of 0.007 to 4 GPa.

Such a polymer may undergo elastic deformation within the pressure range applied to the battery package structure 600. The yield strength at which plastic deformation occurs beyond elastic deformation in the polymer may be about 10 MPa to 80 MPa.

Elasticity may be one of the greatest advantages of a polymer. Elasticity generally refers to the ability of a polymer to gradually return to its original state when force is removed after the shape thereof is deformed by an external force. This restorable deformation is referred to as “elastic deformation”. The point at which this property is destroyed is the yield point. When the yield point is passed, the polymer undergoes plastic deformation, it may not return to its original shape although force is removed from the specimen.

It is known that the mechanical properties of polymers are greatly affected by temperature and strain rate. When the strain rate is low, most polymers maintain elasticity. In this case, the stress and strain are directly proportional. This relationship is known as “Hooke's law”. The slope is the elastic modulus called “Young's modulus”.

The strain rate applied to the all-solid-state battery 10 may be considered very low due to the pressure applied to the cathode layer 100 or the package structure 600.

In addition, the all-solid-state battery 10 increases in temperature depending on operation, but the elastic deformation region of most of the polymers mentioned above may be considered to be within this operation temperature range.

As described above, as lithium ions escape from the cathode active particle 200, when the volume decreases, the movement path through the solid electrolyte 101 may be interrupted during charging and discharging, and thus the resistance may increase.

However, in this case, the movement path may be maintained by which the electrolyte layer 110 may maintain contact with the surface of the cathode active particle 200 due to the shape restoration of the elastic core 120.

In other words, the elasticity of the elastic core 120 may correspond to the restoring force against deformation due to mechanical compression (P, P′) of the cathode layer 200.

In addition, as an exemplary embodiment, the restoring force against deformation due to mechanical compression (P, P′) of the cathode layer 200 may be generated when the size of the cathode active material particle 200 is reduced.

As an exemplary embodiment, the restoring force against deformation due to mechanical compression (P, P′) of the cathode layer 200 may occur when ions escape from the cathode active material particle 200.

In this way, the contact between the cathode active material particle 200 and the electrolyte particle 101 is secured and maintained by the elastic force of the elastic core 120, so that this interface problem may be significantly suppressed.

When external force is applied or deformation occurs, the elastic core 120 may be compressed and reduced in size, so that the size of the electrolyte particle 101 may be reduced or the shape thereof may be deformed. In this process, contact may be maintained between the cathode active material particles 200 and the electrolyte particles 101, according to the elastic force of the elastic core 120.

In addition, when the external force is removed or reduced, the size of the elastic core 120 is restored again, so that contact may be maintained between the cathode active material particles 200 and the electrolyte particles 101.

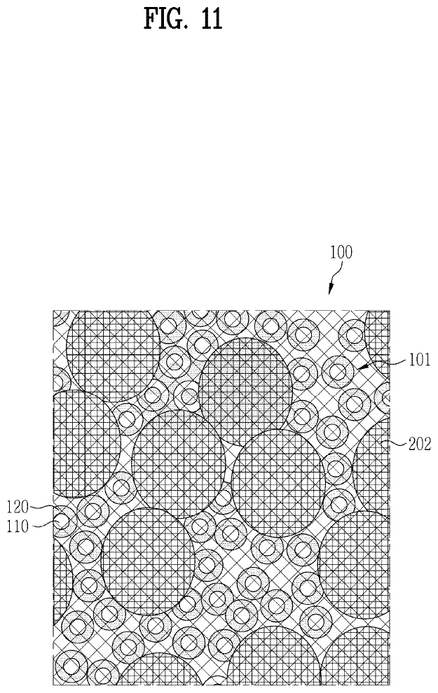

FIG. 11 is a conceptual diagram illustrating an all-solid-state battery according to a second embodiment of the present disclosure.

Referring to FIG. 11, a main configuration of the cathode layer 100 of the all-solid-state battery according to the second embodiment is provided. The all-solid-state battery may include a cathode layer 100 including cathode active material particles 202 and electrolyte particles 101 distributed in contact with the cathode active material particles 202.

Here, the electrolyte particles 101 may include an electrolyte layer 110 coated on an elastic core 120. As an exemplary embodiment, the elastic core 120 may include polymer particles. In addition, the electrolyte layer 110 may be coated on the outer surface of the elastic core 120 having a particle shape.

The thickness of the electrolyte layer 110 may not be significantly limited as long as the electrolyte layer 110 may continuously cover the outer surface of the elastic core 120. That is, the thickness of the electrolyte layer 110 may not be significantly limited as long as it may continuously cover the outer surface of the elastic core 120.

The cathode active material particles 202 may also be referred to as “cathode material” or “cathode activating material particles”. According to the present embodiment, the size of the cathode active material particles 202 may be smaller than the size of the electrolyte particles 101.

These electrolyte particles 101 are surrounded by cathode active material particles 200, so that lithium ions (Li⁺) discharged from the cathode active material particles 202 move through the electrolyte particles 101. In this case, the electrolyte particles 101 include the electrolyte layer 110 coated on the elastic core 120 and lithium ions (Li⁺) may move through the electrolyte layer 120.

In this case, since the electrolyte particle 101 includes an electrolyte layer 110 coated on an elastic core 120 having elasticity, the possibility of a void being formed between the cathode active material particle 200 and the electrolyte particle 101 is significantly reduced, so that an interfacial issue that commonly occurs in an all-solid-state battery may be suppressed.

According to the present embodiment, the size of the electrolyte particles 101 may be smaller than that of the cathode active material particles 202. As can be seen from FIG. 11, the electrolyte particles 101 are distributed between cathode active material particles 202 of relatively large sizes.

The cathode active material particles 202 may be solid and may be lithium, nickel, manganese, cobalt, or the like. However, the embodiment of the present disclosure is not limited thereto.

Meanwhile, the electrolyte layer 110 may be a sulfide-based, oxide-based, polymer-based, or composite-based (hybrid) material containing lithium, but the embodiment of the present disclosure is not limited thereto.

For other parts not described, the same descriptions of the embodiments described above, including the first embodiment, may be applied. Therefore, redundant descriptions are omitted.

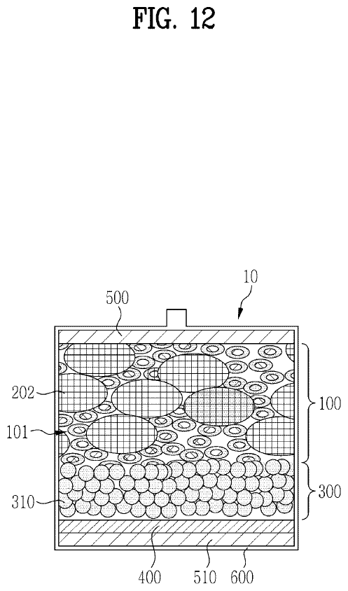

FIG. 12 is a conceptual diagram illustrating the overall structure of the all-solid-state battery according to the second embodiment of the present disclosure.

Referring to FIG. 12, the all-solid-state battery 10 according to the second embodiment of the present disclosure includes the cathode layer 100 described above and the anode collector electrode 500 disposed on one side of the cathode layer 100, and an anode layer 400 may be disposed on the other side of the cathode layer 100. In addition, a solid electrolyte layer 300 may be disposed between the cathode layer 100 and the anode layer 400.

A plurality of solid electrolyte particles 310 may be disposed in the form of layers in the solid electrolyte layer 300 between the cathode layer 100 and the anode layer 400.

As described above, the cathode layer 100 may include cathode active material particles 202 and electrolyte particles 101. Hereinafter, a redundant description of the cathode layer 100 will be omitted.

A solid electrolyte layer 300 may be disposed on one side of the anode layer 400 and a cathode collector 510 may be disposed on the other side of the anode layer 400.

Here, the anode layer 400 may be formed as a metal layer including lithium. At this time, the anode layer 400 may be formed as a very thin layer.

Meanwhile, this all-solid-state battery 10 may further include a package structure 600 configured to package the electrolyte particles 101 in a compressed state. That is, the all-solid-state battery 10 including the electrolyte particles 101 may be maintained in a compressed state by the package structure 600. Here, the package structure 600 is briefly shown. This package structure 600 may include a mechanical structure that may maintain a compressed state (for example, a bolt penetrating the all-solid-state battery 10 and a nut connected to the bolt).

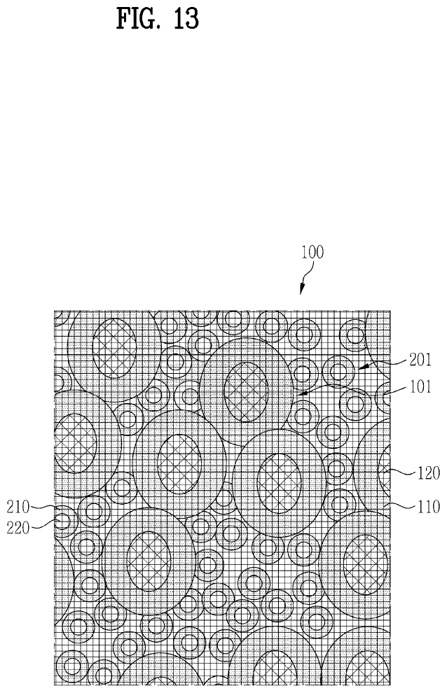

FIG. 13 is a conceptual diagram illustrating an all-solid-state battery according to a third embodiment of the present disclosure.

FIG. 13 mainly shows the cathode layer 100 of the all-solid-state battery according to the third embodiment. This all-solid-state battery may include a cathode layer 100 including cathode active material particles 201 and electrolyte particles 101 distributed in contact with the cathode active material particles 201.

Here, the electrolyte particles 101 may include an electrolyte layer 110 coated on an elastic core 120. As an exemplary embodiment, the elastic core 120 may include polymer particles. In addition, the electrolyte layer 110 may be coated on the outer surface of the elastic core 120 having a particle shape.

The electrolyte layer 110 may have a sufficient thickness to cover the outer surface of the elastic core 120. That is, the thickness of the electrolyte layer 110 may not be significantly limited as long as it may continuously cover the outer surface of the elastic core 120.

The cathode active material particles 200 may also be referred to as “cathode material” or “cathode activating material particles”. According to the present embodiment, the size of the cathode active material particles 201 may be smaller than the size of the electrolyte particles 101.

In the present embodiment, the cathode active material particles 201 may be configured by coating the cathode active material core 220 with the electrolyte layer 210, as described above with reference to FIG. 3.

The thickness of the electrolyte layer 210 may have a thickness sufficient to cover the outer surface of the cathode active material core 220. That is, the thickness of the electrolyte layer 210 may not be significantly limited as long as it may continuously cover the outer surface of the cathode active material core 220.

As such, the surface resistance applied to lithium ions may be further reduced by the cathode active material particles 201 formed by coating the electrolyte layer 210 on the cathode active material core 220.

These cathode active material particles 201 are surrounded by the electrolyte particles 101, so that lithium ions (Li⁺) discharged from the cathode active material particles 201 may move through the electrolyte particles 101. At this time, the electrolyte particles 101 include the electrolyte layer 110 coated on the elastic core 120 and lithium ions (Li⁺) may be moved through the electrolyte layer 120.

At this time, since the electrolyte particle 101 includes an electrolyte layer 110 coated on an elastic core 120 having elasticity, the possibility of a void being formed between the cathode active material particle 201 and the electrolyte particle 101 is significantly reduced, so that an interfacial issue that commonly occurs in an all-solid-state battery may be suppressed.

In addition, since the cathode active material particle 201 is also formed by coating the cathode active material core 220 with an electrolyte layer 210, the mobility of lithium ions discharged from the cathode active material particle 201 may be increased by the electrolyte layer 210.

According to the present embodiment, the size of the electrolyte particle 101 may be larger than that of the cathode active material particle 201. As can be seen from FIG. 13, the cathode active material particles 201 are distributed between relatively large-sized electrolyte particles 101.

The cathode active material particle 201 may be a solid, such as lithium, nickel, manganese, or cobalt. However, the embodiment of the present disclosure is not limited thereto.

Meanwhile, the electrolyte layer 110 may be a sulfide-based, oxide-based, polymer-based, or composite-based (hybrid) material containing lithium. However, the embodiment of the present disclosure is not limited thereto. The electrolyte layer 210 coated on the cathode active material core 220 in the cathode active material particle 201 may also be a sulfide-based, oxide-based, polymer-based, or composite-based (hybrid) material containing lithium.

For other parts not described, the same descriptions of the embodiments described above, including the first embodiment, may be applied. Therefore, redundant descriptions are omitted.

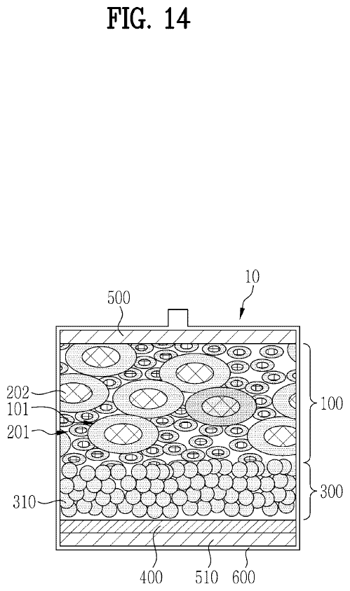

FIG. 14 is a conceptual diagram illustrating the overall structure of the all-solid-state battery according to the third embodiment of the present disclosure.

Referring to FIG. 14, the all-solid-state battery 10 according to the third embodiment of the present disclosure includes the cathode layer 100 described above and an anode collector electrode 500 disposed on one side of the cathode layer 100, and an anode layer 400 may be disposed on the other side of the cathode layer 100. In addition, a solid electrolyte layer 300 may be disposed between the cathode layer 100 and the anode layer 400.

A plurality of solid electrolyte particles 310 may be disposed in the form of layers in the solid electrolyte layer 300 between the cathode layer 100 and the anode layer 400.

As described above, the cathode layer 100 may include cathode active material particles 201 and electrolyte particles 101. Hereinafter, redundant descriptions of the cathode layer 100 will be omitted.

A solid electrolyte layer 300 may be disposed on one side of the anode layer 400 and a cathode collector 510 may be disposed on the other side of the anode layer 400.

Here, the anode layer 400 may be formed as a metal layer containing lithium. At this time, the anode layer 400 may be formed as a very thin layer.

Meanwhile, such an all-solid-state battery 10 may further include a package structure 600 configured to package the compressed electrolyte particles 101. That is, the compressed state of the all-solid-state battery 10 including the electrolyte particles 101 may be maintained by the package structure 600. Here, the package structure 600 is briefly shown. This package structure 600 may include a mechanical structure (for example, a bolt penetrating the all-solid-state battery 10 and a nut connected to the bolt) that may maintain the compressed state.

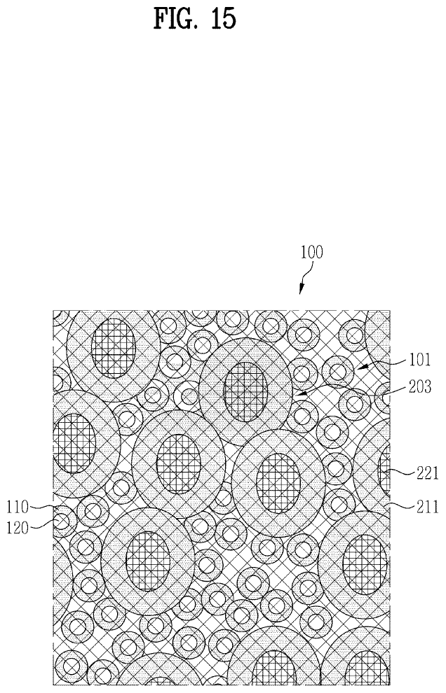

FIG. 15 is a conceptual diagram illustrating an all-solid-state battery according to a fourth embodiment of the present disclosure.

FIG. 15 mainly shows the cathode layer 100 of the all-solid-state battery according to the fourth embodiment. This all-solid-state battery may include a cathode layer 100 including cathode active material particles 203 and electrolyte particles 101 distributed in contact with the cathode active material particles 203.

Here, the electrolyte particle 101 may include an electrolyte layer 110 coated on an elastic core 120. As an exemplary embodiment, the elastic core 120 may include polymer particles. In addition, the electrolyte layer 110 may be coated on the outer surface of the elastic core 120 forming a particle shape.

The electrolyte layer 110 may have a sufficient thickness to cover the outer surface of the elastic core 120. That is, the thickness of the electrolyte layer 110 may not be significantly limited as long as it may continuously cover the outer surface of the elastic core 120.

The cathode active material particle 203 may also be referred to as a “cathode material” or “cathode activating material particle”. According to the present embodiment, the size of the cathode active material particle 203 may be larger than the size of the electrolyte particle 101.

In this embodiment, the cathode active material particle 203 may be configured by coating the cathode active material core 221 with an electrolyte layer 211, as described above with reference to FIG. 3.

The thickness of the electrolyte layer 211 may be sufficient to cover the outer surface of the cathode active material core 221. That is, the thickness of the electrolyte layer 211 may not be significantly limited as long as it may continuously cover the outer surface of the cathode active material core 221.

As such, the surface resistance applied to lithium ions may be further reduced by the cathode active material particle 203 formed by coating the cathode active material core 221 with the electrolyte layer 211.

According to the present embodiment, the electrolyte particles 101 are surrounded by the cathode active material particles 203, so that lithium ions (Li⁺) discharged from the cathode active material particles 203 may move through the electrolyte particles 101. At this time, the electrolyte particles 101 include an electrolyte layer 110 coated on an elastic core 120 and lithium ions (Li⁺) may move through the electrolyte layer 120.

At this time, since the electrolyte particles 101 include an electrolyte layer 110 coated on an elastic core 120 having elasticity, the possibility of a void being formed between the cathode active material particles 203 and the electrolyte particles 101 is significantly reduced, so that the interfacial issue that commonly occurs in all-solid-state batteries may be suppressed.

In addition, since the cathode active material particles 203 are also formed by coating the cathode active material core 221 with the electrolyte layer 211, the mobility of lithium ions discharged from the cathode active material particles 203 may increase due to the electrolyte layer 211.

According to the present embodiment, the size of the electrolyte particles 101 may be smaller than that of the cathode active material particles 203. As can be seen from FIG. 15, the electrolyte particles 101 may be distributed between cathode active material particles 203 having relatively large sizes.

The cathode active material particles 203 may be solid and may be lithium, nickel, manganese, cobalt, or the like. However, the present disclosure is not limited thereto.

Meanwhile, the electrolyte layer 110 may be a sulfide-based, oxide-based, polymer-based, or composite (hybrid) material containing lithium. However, the embodiment of the present disclosure is not limited thereto. The electrolyte layer 211 coated on the cathode active material core 221 in the cathode active material particle 203 may also be a sulfide-based, oxide-based, polymer-based, or composite (hybrid) material containing lithium.

For other parts not described, the same descriptions of the embodiments described above, including the first embodiment, may be applied. Therefore, redundant descriptions are omitted.

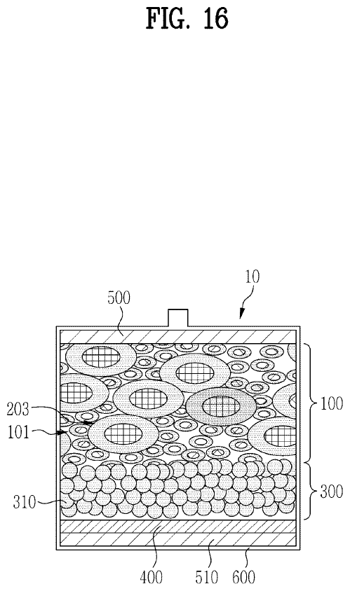

FIG. 16 is a conceptual diagram illustrating the overall structure of the all-solid-state battery according to the fourth embodiment of the present disclosure.

Referring to FIG. 16, the all-solid-state battery 10 according to the fourth embodiment of the present disclosure includes the cathode layer 100 described above and an anode collector electrode 500 disposed on one side of the cathode layer 100, and an anode layer 400 may be disposed on the other side of the cathode layer 100. In addition, a solid electrolyte layer 300 may be disposed between the cathode layer 100 and the anode layer 400.

A plurality of solid electrolyte particles 310 may be disposed in the form of layers in the solid electrolyte layer 300 between the cathode layer 100 and the anode layer 400.

As described above, the cathode layer 100 may include cathode active material particles 203 and electrolyte particles 101. Hereinafter, redundant descriptions of the cathode layer 100 will be omitted.

A solid electrolyte layer 300 may be disposed on one side of the anode layer 400 and a cathode collector 510 may be disposed on the other side of the anode layer 400.

Here, the anode layer 400 may be formed as a metal layer containing lithium. At this time, the anode layer 400 may be formed as a very thin layer.

Meanwhile, such an all-solid-state battery 10 may further include a package structure 600 configured to package the compressed electrolyte particles 101. That is, the compressed state of the all-solid-state battery 10 including the electrolyte particles 101 may be maintained by the package structure 600. Here, the package structure 600 is briefly shown. This package structure 600 may include a mechanical structure (for example, a bolt penetrating the all-solid-state battery 10 and a nut connected to the bolt) that may maintain the compressed state.

The above description is merely provided as an example of the technical idea of the present disclosure and various modifications and variations may be derived by those skilled in the art without departing from the essential characteristics of the present disclosure.

Therefore, the embodiments disclosed in the present disclosure are not intended to limit the technical idea of the present disclosure but to illustrate the same, and these embodiments should not be construed as limiting as the scope of the technical idea of the present disclosure.

The scope of the present disclosure should be interpreted by the claims below, and all technical ideas within the scope equivalent thereto should be interpreted as falling into the scope of the rights of the present disclosure.

### INDUSTRIAL APPLICABILITY

According to the present disclosure, an all-solid-state battery using a solid electrolyte as a secondary battery is provided.

1. An all-solid-state battery using a solid electrolyte, the all-solid-state battery comprising:
a cathode layer comprising:
cathode active material particles; and
electrolyte particles distributed in contact with the cathode active material particles,
wherein the electrolyte particles comprise an electrolyte layer coated on an elastic core.

2. The all-solid-state battery according to claim 1, wherein the elastic core comprises polymer particles.

3. The all-solid-state battery according to claim 1, wherein the cathode layer is provided by mechanical compression.

4. The all-solid-state battery according to claim 3, an elasticity of the elastic core corresponds to a restoring force against deformation of the cathode layer due to mechanical compression.

5. The all-solid-state battery according to claim 4, wherein the restoring force is formed when a size of the cathode active material particles is reduced.

6. The all-solid-state battery according to claim 4, wherein the restoring force is formed when ions escape from the cathode active material particles.

7. The all-solid-state battery according to claim 3, further comprising a package structure configured to package the electrolyte particles in a compressed state.

8. The all-solid-state battery according to claim 1, wherein the cathode active material particles are coated with an electrolyte.

9. The all-solid-state battery according to claim 1, wherein a size of the electrolyte particles is larger than a size of the cathode active material particles.

10. An all-solid-state battery comprising:
a cathode layer;
an anode layer; and
a solid electrolyte layer disposed between the cathode layer and the anode layer,
wherein the cathode layer comprises electrolyte particles including an electrolyte layer coated on an elastic core.

11. The all-solid-state battery according to claim 10, wherein the cathode layer further comprises cathode active material particles contacting the electrolyte particles.

12. The all-solid-state battery according to claim 11, wherein the cathode active material particles are coated with an electrolyte.

13. The all-solid-state battery according to claim 11, wherein a size of the electrolyte particles is larger than a size of the cathode active material particles.

14. The all-solid-state battery according to claim 10, wherein the electrolyte particles are provided by mechanical compression between the cathode layer and the anode layer.

15. The all-solid-state battery according to claim 14, an elasticity of the elastic core corresponds to a restoring force against deformation of the cathode layer due to mechanical compression.

16. The all-solid-state battery according to claim 15, wherein the restoring force is formed when a size of the cathode active material particles is reduced.

17. The all-solid-state battery according to claim 15, wherein the restoring force is formed when ions escape from the cathode active material particles.

18. The all-solid-state battery according to claim 10, further comprising a package structure configured to package the electrolyte particles in a compressed state.
